(19) United States
(12) Patent Application Publication
(10) Pub. No.: US 2007/0162268 A1
(43) Pub. Date: Jul. 12, 2007

(54) Algorithmic electronic system level design platform

(76) Inventors: Bhaskar Kota, San Jose, CA (US); Paul L. Master, Sunnyvale, CA (US); Robert William Barker, San Jose, CA (US); Robert Plunkett, Sunnyvale, CA (US)

Correspondence Address: GAMBURD LAW GROUP LLC, 600 WEST JACKSON BLVD., SUITE 625, CHICAGO, IL, 60661, US

(21) Appl. No.: 11/331,565

(22) Filed: Jan. 12, 2006

(51) Int. Cl. G06F 17/50

(52) U.S. Cl. 703/14

(57) ABSTRACT

A computing system and method are provided for algorithmic electronic system level design. An exemplary system comprises a plurality of databases for storing a plurality of functional models, a plurality of computational element models, and a plurality of hardware definition representations. An application design processor is adapted to perform a first functional simulation of an algorithm using a plurality of computational element architecture definitions to generate a first selection of a plurality of computational elements and corresponding control code for an implementation of the algorithm. A control and memory modeling processor is adapted to generate a plurality of flow transforms from the algorithm and to convert the plurality of flow transforms into the plurality of plurality of computational element models. A system simulation processor is adapted to convert the plurality of computational element models into the plurality of hardware definition representations and to perform a second functional simulation of the algorithm using the plurality of computational element models corresponding to the first selection and the corresponding control code.

### CROSS-REFERENCE TO A RELATED APPLICATION

This application is related to and claims priority to U.S. patent application Ser. No. ______, filed concurrently herewith, inventor Bhaskar Kota, entitled “Flow Transform For Integrated Circuit Design And Simulation Having Combined Data Flow, Control Flow, And Memory Flow Views”, which is commonly assigned herewith, the contents of which are incorporated herein by reference, and with priority claimed for all commonly disclosed subject matter.

### FIELD OF THE INVENTION

The present invention relates, in general, to electronic design automation and electronic system level design automation for integrated circuits and applications and, more particularly, to an algorithmic electronic system level method, system and software for integrated application development for and design and simulation of integrated circuitry.

### BACKGROUND OF THE INVENTION

Electronic Design Automation (“EDA”) and Electronic System Level (“ESL”) design and simulation tool suites for integrated circuits (“ICs”) have evolved for a wide variety of architecture platforms, such as for embedded microprocessors, digital signal processors (“DSPs”), and application-specific integrated circuits (“ASICs”). In many instances, such design tool suites provide for acceleration of some computationally intensive tasks in custom hardware, with execution control and performance of other tasks retained in an embedded, instruction-based processor.

Much of the prior art EDA design and simulation tools have been designed to optimize gate-level performance in an IC and verify functionality at this detailed hardware level. These EDA tool suites, however, have been unable to integrate this level of verification with system level designs and requirements, for testing and verifying algorithmic performance and power and control specifications, for example.

In addition, prior art EDA and ESL design and simulation tool suites have generally been inapplicable to data flow processing architectures or data streaming architectures, which are designed to execute whenever input data exists and provide corresponding output data. Such data flow architectures have typically been difficult to design and model because typical data flow models, while accounting for data input and output, have insufficient control information for execution control and further fail to account for memory requirements, movements and flows. In addition, such prior art data flow models do not provide sufficient interface information or provide incompatible interfaces, so that one dataflow element cannot be connected automatically to another dataflow element. Indeed, prior art design and simulation tools instead assume infinite memory availability for data flow modeling. In addition, current design and simulation tool suites do not provide for self-contained, data-flow based task modules, which may be utilized for implementing more than one algorithm.

Traditional ESL design platforms have been unable to design efficient architectures without significant knowledge of the algorithms which will run on those architectures. Software (such as C, C++ or assembly code) may be considered merely a simulation model for a given architecture using Turing methods. As a consequence, a need remains for an ESL design platform which can incorporate optimized algorithms to create high quality IC systems which meet, if not surpass, performance and power requirements.

Prior art EDA and ESL design and simulation tool suites also have not provided an integrated environment for both architecture design (including data flow architecture design) and application development. In addition, prior art EDA and ESL design and simulation tool suites have not provided for functional simulation of algorithms concurrent with hardware simulations of the performance of the algorithm on the actual target IC. In prior art EDA and ESL design, separate sets of “test benches” are required and are created multiple times during the course of a design cycle.

As a consequence, a need remains for a design and simulation tool flow which can integrate both control flow and memory flow with data flow, and utilize such an integrated view to simulate and model computational elements which will implement a selected algorithm on an IC. Such a design and simulation platform should generate appropriate control and memory requirements, and provide a common platform for application development, using a modular and integrated data flow model having both control and memory flow and a modular, well-defined interface. A design and simulation platform should also provide an integrated solution, allowing an application developer to perform both a functional simulation of an algorithm or program and to concurrently perform a hardware simulation of the algorithm based upon the target architecture. Such a design and simulation tool suite should also provide for mapping of the algorithm directly to the target IC architecture, with the provision of a resulting compilation of the algorithm for the target IC architecture.

### SUMMARY OF THE INVENTION

The exemplary embodiments of the invention provide an Algorithmic Electronic System Level (Algorithmic ESL or “AESL”) design and simulation platform, embodied as a system, methodology and software. The exemplary embodiments incorporate algorithmic representations into both application development and hardware development, providing a significant advance over current methodologies of hardware and software co-design.

Algorithmic representations are utilized as part of hardware (IC) design, and provide integrated modules for use in application development, functional verification and hardware verification. In exemplary embodiments, algorithmic representations may then be represented rather automatically in software or dataflow, functionally verified, and may then be mapped, simulated and verified concurrently with the target IC architecture. In addition, the models generated as part of the hardware verification process may then be utilized directly by a compiler for generation of corresponding code or netlists for performance of the algorithm on the target IC architecture.

Algorithmic representations are utilized as part of IC (hardware) design, utilizing an instruction (or control or compute primitive) and memory-based modeling platform. This platform provides an integrated “flow transform” which has a combined data flow representation, control representation, a memory representation, and an interface representation. The flow transform is architecture neutral. Each flow transform is also interface neutral, having a well-defined but generic interface, allowing a plurality of flow transforms to be interconnected (via memory interconnect for modeling) to define an algorithm. The instruction (or control) and memory-based modeling platform is also utilized to generate hardware descriptions, such as in a concurrent modeling language or system such as SystemC descriptions, which may then be modeled utilizing an integrated, system modeling and simulation platform, such as a SystemC modeling platform.

In addition, using the inventive and integrated Algorithmic ESL design platform, an application developer may rely upon on all of these various detailed functional and behavioral models and work at a higher level of abstraction, with all of the information from the various detailed views “rolled-up” or integrated into these higher, more abstract levels. In addition, as may be necessary or desirable, the application designer may also “drill-down” into the more detailed views and simulations, particularly to select among alternative architectures and implementations. When the application has been completed, the application may also be compiled directly for operation on the selected IC architecture.

A first exemplary method embodiment, for developing and simulating an integrated circuit architecture, comprises: (a) inputting an algorithm using an instruction language or computational primitive having control information; (b) decomposing the algorithm to a plurality of tasks having a first selected abstraction level; (c) for each task of the plurality of tasks, determining and combining data flow, control flow, and memory flow to form a flow transform of a corresponding plurality of flow transforms; (d) connecting the plurality of flow transforms using an interconnect between each flow transform to provide an algorithm representation; and (e) simulating the connected flow transforms.

The simulation step (e) may generate computation data paths, computation control, data flow interfaces, and memory requirements and statistics. The interconnect may be at least one of the following: a memory, a first-in first-out (FIFO) memory, a buffer, a circular buffer, a constant value, a switch, or a bus. In addition, the method may also include generating a hardware description of a plurality of computational elements comprising the plurality of flow transforms, wherein the hardware description is SystemC, Verilog, or VHDL.

In exemplary embodiments, the decomposition step (b) is hierarchical and preserves control information, either as part of the flow transform or separate from the flow transform. Also in exemplary embodiments, the simulation step (e) generates control bits for control of computational elements selected to implement a corresponding flow transform; may also generate the number and type of computational elements utilized to implement a corresponding flow transform; and also may generate a plurality of quantitative measures, the plurality of quantitative measures including time spent by data operands in interconnect, time spent by data operands in a compute path. The inputting step (a) may further comprises inputting a power, cycle, latency, or size requirement (P3 requirement), while the simulation step (e) may generate a plurality of quantitative measures (P3), such as power dissipation, integrated circuit size, and cycles utilized.

In another exemplary embodiment, a computer-implemented method for developing and simulating an integrated circuit architecture, comprises: (a) determining at least one task corresponding to an algorithm; (b) for the at least one task, determining data flow, control flow, and memory flow to form a flow transform; (c) providing a corresponding interconnect for input to and output from the flow transform; and (d) using a processing device, simulating the flow transform having the memory interconnect. The simulation step (d) may further comprises at least one of the following simulations: individually simulating data flow, individually simulating control flow, individually simulating memory flow, or simulating any selected combination of data flow, control flow, or memory flow.

In exemplary embodiments, the method may also include inputting an algorithm using an instruction language or computational primitive having control information and interface information; extracting parallel computation capability; and hierarchically decomposing the algorithm to form a plurality of tasks having a first selected abstraction level, the plurality of tasks including the at least one task. The interface information may be at least one of the following: a data type, a data width, an amount or number of bytes, a latency, a delay. In addition, the method may also include generating control bits for control of computational elements selected to implement a corresponding flow transform.

In another exemplary embodiment, a system for developing and simulating an integrated circuit architecture comprises: an interface to receive an algorithm having control information; a memory; and a processor coupled to the interface and to the memory, the processor adapted to simulate a plurality of flow transforms connected using a memory interconnect to represent the algorithm, at least one flow transform of the plurality of flow transforms comprising data flow, control flow, and memory flow of a corresponding task of the algorithm.

In another exemplary embodiment, a machine-readable medium storing instructions for developing and simulating an integrated circuit architecture comprises: a first program construct for determining at least one task corresponding to an algorithm; a second program construct for determining data flow, control flow, and memory flow to form a flow transform for the at least one task; a third program construct for providing a corresponding memory interconnect for input to and output from the flow transform; and a fourth program construct for simulating the flow transform having the memory interconnect.

In exemplary embodiments, the machine-readable medium may also include a fifth program construct for inputting an algorithm using an instruction language having control information; a sixth program construct for hierarchically decomposing the algorithm to form a plurality of tasks having a first selected abstraction level, the plurality of tasks including the at least one task; a seventh program construct for generating a hardware description of a plurality of computational elements comprising the plurality of flow transforms, wherein the hardware description is SystemC, Verilog, or VHDL, and for generating control bits for control of computational elements selected to implement a corresponding flow transform.

In another exemplary embodiment, a method for developing and simulating an integrated circuit architecture comprises: inputting an algorithm having control information and inputting a power or performance requirement; hierarchically decomposing the algorithm to a plurality of tasks having a first selected abstraction level; for each task of the plurality of tasks, determining and combining data flow, control flow, and memory flow to form a flow transform of a corresponding plurality of flow transforms; connecting the plurality of flow transforms using a first-in first-out memory interconnect between each flow transform to provide an algorithm representation; simulating the connected flow transforms; generating a hardware description of a plurality of computational elements comprising the plurality of flow transforms; modeling the plurality of computational elements; and generating control bits for control of computational elements selected to implement a corresponding flow transform.

In an exemplary embodiment, a computer-implemented method for electronic system level design and verification is also provided. An exemplary method comprises: (a) receiving an application as design input; (b) performing a first functional simulation of the application to provide a functional application model; (c) verifying the functional application model; (d) providing the verified functional application model in a hardware simulation compatible format; (e) performing a second functional simulation using the verified functional application model in the hardware simulation compatible format and using an integrated circuit architecture model to provide a functional architecture model; and (f) comparing the functional architecture model with the verified functional application model. The exemplary method may also include generating a plurality of cycle-accurate, transactional-accurate, or functionally-accurate computational element models, generally in the hardware simulation compatible format; and incorporating the plurality of cycle-accurate, transactional-accurate, or functionally-accurate computational element models into the integrated circuit architecture model.

In exemplary embodiments, the step (a) of receiving the application may also further comprise: receiving a plurality of architecture definition files; receiving a plurality of dataflow diagrams; and receiving performance specifications. In addition, the step (d) of providing the verified functional model may also further Comprise: providing the verified functional application model as an application netlist of computational elements and interconnections. In exemplary embodiments, the method may also include verifying the functional architecture model; and using the verified functional architecture model, compiling the application to an integrated circuit architecture represented by the integrated circuit architecture model.

In another exemplary embodiment, a computing system for algorithmic electronic system level design comprises: a plurality of databases, a first database of the plurality of databases adapted to store a plurality of functional models, a second database of the plurality of databases adapted to store a plurality of computational element models, and a third database of the plurality of databases adapted to store a plurality of hardware definition representations; an application design processor coupled to the first database, the application design processor adapted to perform a first functional simulation of an algorithm using a plurality of computational element architecture definitions to generate a first selection of a plurality of computational elements and corresponding control code for an implementation of the algorithm; a control and memory modeling processor coupled to the second database, the control and memory modeling processor adapted to generate a plurality of flow transforms from the algorithm and to convert the plurality of flow transforms into the plurality of plurality of computational element models; and a system simulation processor coupled to the second databases and the third database, the system simulation processor adapted to convert the plurality of computational element models into the plurality of hardware definition representations and to perform a second functional simulation of the algorithm using the plurality of computational element models corresponding to the first selection and the corresponding control code.

In exemplary embodiments, the control and memory modeling processor may be further adapted to generate the plurality of flow transforms from the algorithm coded in an instruction-based language, and may also combine data flow, control flow, and memory flow information to generate a flow transform of the plurality of flow transforms. The system simulation processor may be further adapted to generate a cycle-accurate computational element model of the plurality of computational element models which further comprises control information for configuration of a configurable computational element.

In another exemplary embodiment, a system for electronic system level design and verification comprises: a first processor adapted to receive an application as design input, perform a first functional simulation of the application to provide a functional application model, verifying the functional application model, and provide the verified functional application model in a hardware simulation compatible format; and a second processor coupled to the first processor, the second processor adapted to perform a second functional simulation using the verified functional application model in the hardware simulation compatible format and using an integrated circuit architecture model to provide a functional architecture model. In exemplary embodiments, the system may also include a third processor coupled to the first processor and to the second processor, the third processor adapted to determine a plurality of architecture definition files and to provide the plurality of architecture definition files as input to the first processor.

In exemplary embodiments, the second processor may be further adapted to generate a plurality of cycle-accurate computational element models in the hardware simulation compatible format and to incorporate the plurality of cycle-accurate computational element models into the integrated circuit architecture model. The first processor may also be further adapted to provide the verified functional application model as an application netlist of computational elements and interconnections; and to verify the functional architecture model. In exemplary embodiments, the system may also include a fourth processor coupled to the second processor, the fourth processor adapted to use the verified functional architecture model to compile the application to an integrated circuit architecture represented by the integrated circuit architecture model.

In another exemplary embodiment, a system for algorithmic electronic system level design comprises: an interface for receiving an algorithmic description; a memory adapted to store a plurality of computational element architecture definitions and a plurality of cycle-accurate computational element models; and a processor coupled to the memory and to the interface, the processor adapted to perform a first functional simulation of the algorithm using the plurality of computational element architecture definitions to generate a first selection of a plurality of computational elements and corresponding control code for an implementation of the algorithm; and to perform a second functional simulation of the algorithm using a plurality of cycle-accurate computational element models corresponding to the first selection and the corresponding control code.

In exemplary embodiments, the algorithm is defined by a plurality of interconnected dataflow diagrams. The processor may be further adapted to map the plurality of interconnected dataflow diagrams to a corresponding plurality of computational elements; and generate an interconnection among the corresponding plurality of computational elements as defined by the plurality of interconnected dataflow diagrams. Also, the processor may be further adapted to convert the algorithm into a plurality of flow transforms, and to combine data flow, control flow, and memory flow information to generate a flow transform of the plurality of flow transforms.

In exemplary embodiments, the processor may be further adapted to generate a cycle-accurate computational element model of the plurality of cycle-accurate computational element models which further comprises control information for configuration of a configurable computational element. The processor also may be further adapted to perform the second functional simulation utilizing a plurality of integrated circuit architecture models, the plurality of models comprising at least two of the following models: an interconnect model, a memory model, an input and output model, a clocking model, and an integrated circuit operating system model.

In another exemplary embodiment, the processor is further adapted to perform a third functional simulation using the plurality of computational element architecture definitions to generate a second selection of a plurality of computational elements and corresponding control code for an implementation of the algorithm; to perform a fourth functional simulation of the algorithm using a plurality of cycle-accurate computational element models corresponding to the second selection and the corresponding control code; and to compare the second functional simulation and fourth functional simulation.

In exemplary embodiments, the processor may be further adapted to perform the first and second functional simulations at a plurality of levels of abstraction. In addition, the processor may be further adapted to roll-up a plurality of parameters from a each level of abstraction to the next higher level of abstraction.

In another exemplary embodiment, a system for algorithmic electronic system level design comprises: a plurality of databases, a first database of the plurality of databases adapted to store a plurality of computational element architecture definitions, a second database of the plurality of databases adapted to store a plurality of cycle-accurate computational element models, and a third database of the plurality of databases adapted to store a hardware definition representation of the plurality of cycle-accurate computational element models; and a processor coupled to the plurality of databases, the processor adapted to perform a first functional simulation of an algorithm using the plurality of computational element architecture definitions to generate a first selection of a plurality of computational elements and corresponding control code for an implementation of the algorithm; and to perform a second functional simulation of the algorithm using a plurality of cycle-accurate computational element models corresponding to the first selection and the corresponding control code.

In another exemplary embodiment, a computer-implemented method for algorithmic electronic system level design and simulation comprises: (a) inputting an algorithm; (b) providing a plurality of computational element architecture definitions; (c) functionally simulating the algorithm using the plurality of computational element architecture definitions; (d) generating from the functional simulation a first selection of a plurality of computational elements and corresponding control code for an implementation of the algorithm; and (e) functionally simulating the algorithm using a plurality of cycle-accurate computational element models corresponding to the first selection and the corresponding control code.

The algorithm may be defined by a plurality of interconnected dataflow diagrams. The functional simulation step (b) may further comprise: mapping the plurality of interconnected dataflow diagrams to a corresponding plurality of computational elements; and generating an interconnection among the corresponding plurality of computational elements as defined by the plurality of interconnected dataflow diagrams.

In exemplary embodiments, the method may also include (d1) generating from the functional simulation a second selection of a plurality of computational elements and corresponding control code for an implementation of the algorithm; (e1) functionally simulating the algorithm using a plurality of cycle-accurate computational element models corresponding to the second selection and the corresponding control code; and (f1) comparing the functional simulations using the first selection and the second selection.

In another exemplary embodiment, a machine-readable medium storing instructions for electronic system level design and verification comprises: a first program construct for receiving an application as design input and receiving a plurality of architecture definition files, the plurality of architecture definition files having been determined from control and memory-based integrated circuit modeling; a second program construct for performing a first functional simulation of the application to provide a functional application model; a third program construct for verifying the functional application model; a fourth program construct for providing the verified functional application model in a hardware simulation compatible format; a fifth program construct for performing a second functional simulation using the verified functional application model in the hardware simulation compatible format and using an integrated circuit architecture model to provide a functional architecture model; and a sixth program construct for comparing the functional architecture model with the verified functional application model.

In exemplary embodiments, the machine-readable medium may also include a seventh program construct for generating a plurality of cycle-accurate, transactional-accurate, or functionally-accurate computational element models; an eighth program construct for incorporating the plurality of cycle-accurate, transactional-accurate, or functionally-accurate computational element models into the integrated circuit architecture model; a ninth program construct for providing the verified functional application model as an application netlist of computational elements and interconnections; a tenth program construct for verifying the functional architecture model; and/or an eleventh program construct for compiling the application, using the verified functional architecture model, to an integrated circuit architecture represented by the integrated circuit architecture model.

These and additional embodiments are discussed in greater detail below. Numerous other advantages and features of the present invention will become readily apparent from the following detailed description of the invention and the embodiments thereof, from the claims and from the accompanying drawings.

### BRIEF DESCRIPTION OF THE DRAWINGS

The objects, features and advantages of the present invention will be more readily appreciated upon reference to the following disclosure when considered in conjunction with the accompanying drawings and examples which form a portion of the specification, wherein like reference numerals are used to identify identical components in the various views, in which:

FIG. 1 is a block diagram illustrating exemplary system and apparatus embodiments in accordance with the teachings of the present invention.

FIG. 2, divided into FIGS. 2A and 2B, is a flow diagram illustrating an exemplary method embodiment in accordance with the teachings of the present invention.

FIG. 3 is a diagram illustrating an exemplary hierarchical processing block decomposition in accordance with the teachings of the present invention.

FIG. 4 is a block diagram illustrating an exemplary hierarchical processor decomposition for a portion of a H.264 decoder in accordance with the teachings of the present invention.

FIG. 5 is a block diagram illustrating an exemplary flow transform and FIFO connection for system modeling and simulation in accordance with the teachings of the present invention.

FIG. 6 is a block and flow diagram illustrating an exemplary Algorithmic ESL design, simulation and modeling automation platform system embodiment in accordance with the teachings of the present invention.

FIG. 7 is a flow diagram providing another illustration of the exemplary Algorithmic ESL design, simulation and modeling automation platform system embodiment in accordance with the teachings of the present invention.

FIG. 8 is a flow diagram illustrating an exemplary method embodiment for automated design, simulation and modeling of integrated circuitry in accordance with the teachings of the present invention.

### DETAILED DESCRIPTION OF EXEMPLARY EMBODIMENTS

While the present invention is susceptible of embodiment in many different forms, there are shown in the drawings and will be described herein in detail specific examples and embodiments thereof, with the understanding that the present disclosure is to be considered as an exemplification of the principles of the invention and is not intended to limit the invention to the specific examples and embodiments illustrated, and that numerous variations or modifications from the described embodiments may be possible and are considered equivalent.

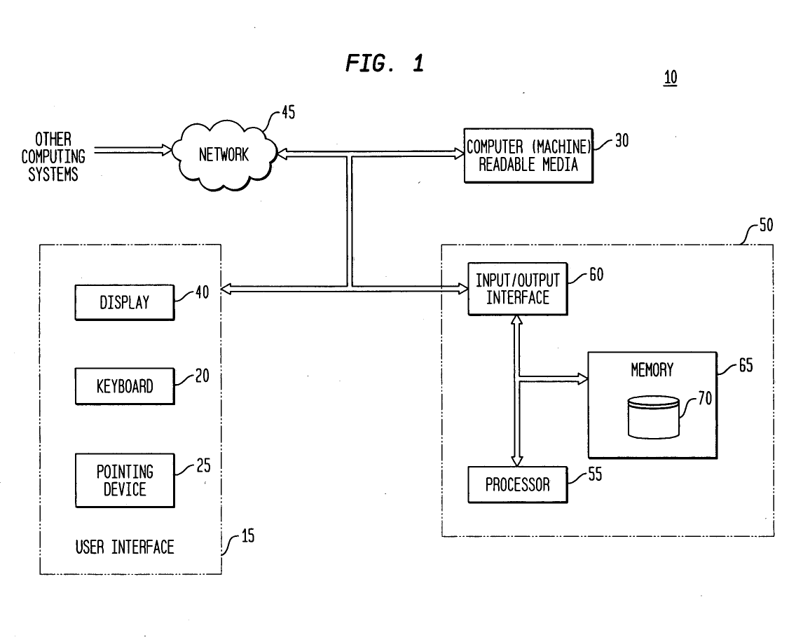

FIG. 1 is a block diagram illustrating exemplary system 10 and apparatus 50 embodiments in accordance with the teachings of the present invention. As illustrated, the apparatus 50 may be embodied as any type of computer such as a personal computer, a workstation, a mainframe computer, a server, or any other type of processing or modeling device utilized in the IC design fields. Any data input for the system 10 may be provided through any of a plurality of input sources, such as by a user directly through a user interface 15 (having keyboard 20, pointing device 25, and display 40), in the form of electronic data (e.g., electronic files), through a network 45 (such as the Internet, a local area network (“LAN”), a wide area network (“WAN”), a proprietary or corporate network, a cable network, or the public switched telephone network, for example), or through other forms of computer (machine) readable media 30, such as network hard drives, optical drives, tape drives, a floppy disk, a CD-ROM, a memory card, and other media discussed below. For example, an individual may utilize the user interface 15 and apparatus 50 to input program language or code, such as utilizing an instruction set architecture language, for creating a data flow architecture in accordance with the present invention.

Similarly, data output from the apparatus 50 may be provided to any of a plurality of output devices such as an electronic display 40, such as a CRT, plasma or LCD display, or a printer (e.g., a laser or inkjet printer) (not separately illustrated), for example. In addition, output may also be provided in the form of electronic data through network 45 or machine-readable media 30, such as to transmit to another location or a remote location.

As illustrated in FIG. 1, the apparatus 50 comprises a processor 55, an input and output (“I/O”) interface (or other I/O means) 60, and a memory 65 (which may further comprise the data repository 70). In the apparatus 50, the interface 60 may be implemented as known or may become known in the art, to provide data communication between, first, the processor 55, memory 65 and/or data repository 70, and second, any of the various input and output devices, mechanisms and media discussed herein, including wireless, optical or wireline, using any applicable standard, technology, or media, without limitation. In addition, the I/O interface 60 may provide an interface to any CD or disk drives, or an interface to a communication channel for communication via network 45, or an interface for a universal serial bus (USB), for example. In other embodiments, the interface 60 may simply be a bus (such as a PCI or PCI Express bus) to provide communication with any form of media or communication device, such as providing an Ethernet port, for example. Also for example, the I/O interface 60 may provide all signaling and physical interface functions, such as impedance matching, data input and data output between external communication lines or channels (e.g., Ethernet, T1 or ISDN lines) coupled to a network 45, and internal server or computer communication busses (e.g., one of the various PCI or USB busses), for example and without limitation. In addition, depending upon the selected embodiment, the I/O interface 60 (or the processor 55) may also be utilized to provide data link layer and media access control functionality.

The memory 65, which may include a data repository (or database) 70, may be embodied in any number of forms, including within any computer or other machine-readable data storage medium, memory device or other storage or communication device for storage or communication of information such as computer-readable instructions, data structures, program modules or other data, currently known or which becomes available in the future, including, but not limited to, a magnetic hard drive, an optical drive, a magnetic disk or tape drive, a hard disk drive, other machine-readable storage or memory media such as a floppy disk, a CDROM, a CD-RW, digital versatile disk (DVD) or other optical memory, a memory integrated circuit (“IC”), or memory portion of an integrated circuit (such as the resident memory within a processor IC), whether volatile or non-volatile, whether removable or non-removable, including without limitation RAM, FLASH, DRAM, SDRAM, SRAM, MRAM, FeRAM, ROM, EPROM or E²PROM, or any other type of memory, storage medium, or data storage apparatus or circuit, which is known or which becomes known, depending upon the selected embodiment. In addition, such computer readable media includes any form of communication media which embodies computer readable instructions, data structures, program modules or other data in a data signal or modulated signal, such as an electromagnetic or optical carrier wave or other transport mechanism, including any information delivery media, which may encode data or other information in a signal, wired or wirelessly, including electromagnetic, optical, acoustic, RF or infrared signals, and so on. The memory 65 is adapted to store various programs or instructions (of the software of the present invention) and database tables, discussed below.

The apparatus 50 further includes one or more processors 55, adapted to perform the functionality discussed below. As the term processor is used herein, a processor 55 may include use of a single integrated circuit (“IC”), or may include use of a plurality of integrated circuits or other components connected, arranged or grouped together, such as microprocessors, digital signal processors (“DSPs”), parallel processors, multiple core processors, custom ICs, application specific integrated circuits (“ASICs”), field programmable gate arrays (“FPGAs”), adaptive computing ICs, associated memory (such as RAM, DRAM and ROM), and other ICs and components. As a consequence, as used herein, the term processor should be understood to equivalently mean and include a single IC, or arrangement of custom ICs, ASICs, processors, microprocessors, controllers, FPGAs, adaptive computing ICs, or some other grouping of integrated circuits which perform the functions discussed below, with associated memory, such as microprocessor memory or additional RAM, DRAM, SDRAM, SRAM, MRAM, ROM, FLASH, EPROM or E²PROM. A processor (such as processor 55), with its associated memory, may be adapted or configured (via programming, FPGA interconnection, or hard-wiring) to perform the methodology of the invention, as discussed below. For example, the methodology may be programmed and stored, in a processor 55 with its associated memory (and/or memory 65) and other equivalent components, as a set of program instructions or other code (or equivalent configuration or other program) for subsequent execution when the processor is operative (i.e., powered on and functioning). Equivalently, when the processor 55 may implemented in whole or part as FPGAs, custom ICs and/or ASICs, the FPGAs, custom ICs or ASICs also may be designed, configured and/or hard-wired to implement the methodology of the invention. For example, the processor 55 may implemented as an arrangement of microprocessors, DSPs and/or ASICs, collectively referred to as a “processor”, which are respectively programmed, designed, adapted or configured to implement the methodology of the invention, in conjunction with one or more databases (70) or memory 65.

As indicated above, the processor 55 is programmed, using software and data structures of the invention, for example, to perform the methodology of the present invention. As a consequence, the system and method of the present invention may be embodied as software which provides such programming or other instructions, such as a set of instructions and/or metadata embodied within a computer readable medium, discussed above. In addition, metadata may also be utilized to define the various data structures of database 70, such as to store the various color management models and calibrations discussed below.

More generally, the system, methods, apparatus and programs of the present invention may be embodied in any number of forms, such as within any type of apparatus (computer or server) 50, within a processor 55, within a computer network, within an adaptive computing device, or within any other form of computing or other system used to create or contain source code, including the various processors and computer readable media mentioned above. Such source code further may be compiled into some form of instructions or object code (including assembly language instructions or configuration information). The software, source code or metadata of the present invention may be embodied as any type of code, such as C, C++, SystemC, LISA, XML, Java, Brew, SQL and its variations (e.g., SQL 99 or proprietary versions of SQL), DB2, Oracle, or any other type of programming language which performs the functionality discussed herein, including various hardware definition or hardware modeling languages (e.g., Verilog, VHDL, RTL) and resulting database files (e.g., GDSII). As a consequence, a “construct”, “program construct”, “software construct” or “software”, as used equivalently herein, means and refers to any programming language, of any kind, with any syntax or signatures, which provides or can be interpreted to provide the associated functionality or methodology specified (when instantiated or loaded into a processor or computer and executed, including the apparatus 50 or processor 55, for example). For example, various versions of the software may be embodied using the instruction set architecture language LISA.

The software, metadata, or other source code of the present invention and any resulting bit file (object code, database, or configuration bit sequence) may be embodied within any tangible storage medium, such as any of the computer or other machine-readable data storage media, as computer-readable instructions, data structures, program modules or other data, such as discussed above with respect to the memory 65, e.g., a floppy disk, a CDROM, a CD-RW, a DVD, a magnetic hard drive, an optical drive, or any other type of data storage apparatus or medium, as mentioned above.

In addition, while the present invention is frequently illustrated with respect to simulation and modeling systems available from selected vendors, it should be understood that any simulation, modeling and IC architecture design systems can be utilized with and are within the scope of the present invention.

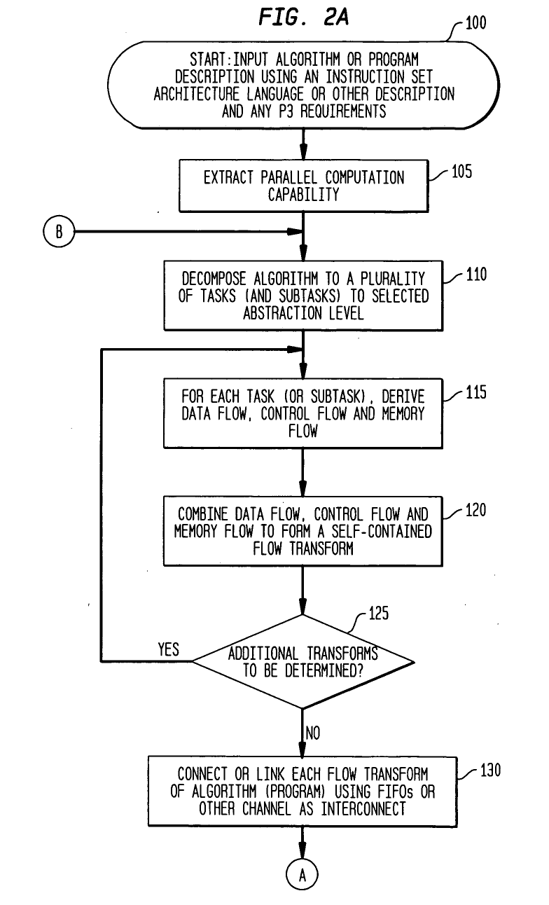

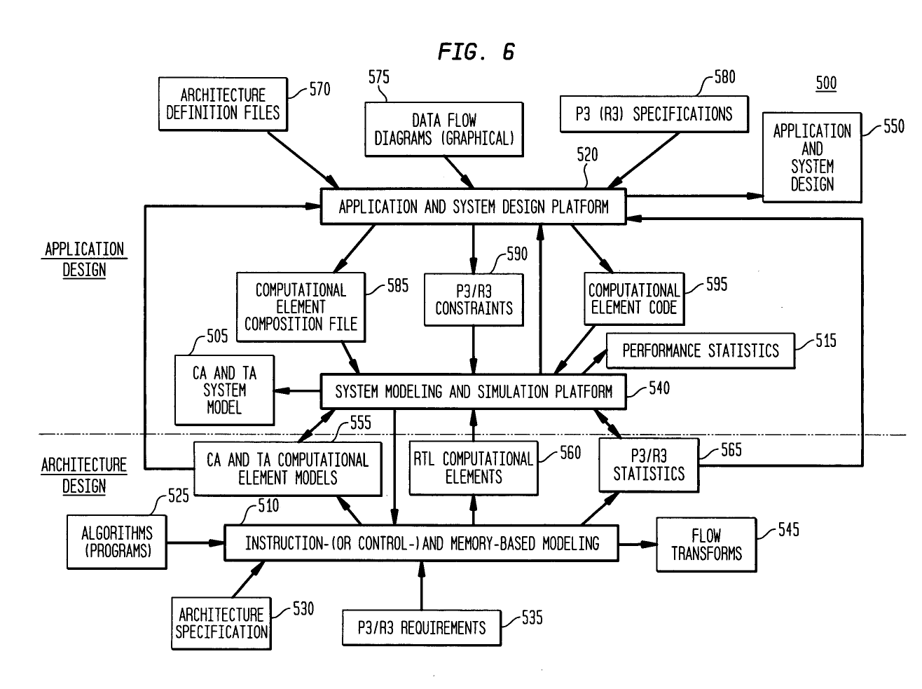

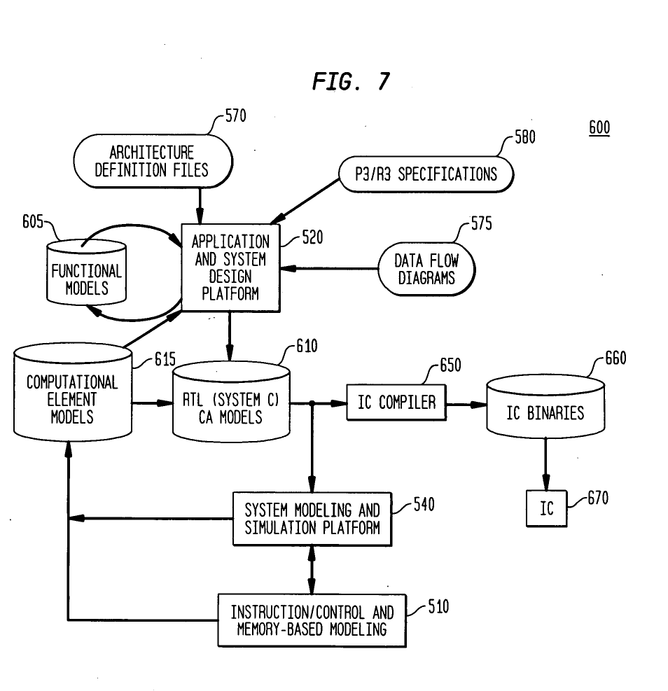

The exemplary embodiments of the present invention may be referred to as Algorithmic ESL (“AESL”) and divided into two categories, an architecture design platform and an application design platform. The architecture design platform is illustrated primarily with reference to FIGS. 2-5. The application design platform is illustrated primarily with reference to FIGS. 6-7.

FIG. 2 is a flow diagram illustrating an exemplary method embodiment in accordance with the teachings of the present invention, and is utilized primarily as part of the architecture design platform. The method begins, start step 100, with input of an algorithm or program description using an instruction set architecture language description, such as input through the user interface 15. As used herein, “instruction” is to be broadly interpreted, to include any compute or computational primitive (e.g., a+b), in addition to other means of specifying computations and control. In addition, as part of step 100, P3 requirements such as power, performance or price goals or specifications may also be input. Also as part of step 100, other design goals may also be input, such as resiliency, reliability, and robustness requirements (referred to as “R3” requirements). An instruction set architecture language is utilized in the exemplary embodiment to preserve control information for subsequent extraction into a data flow model and the flow transforms of the present invention. In an exemplary embodiment, the selected language is LISA (Language for Instruction Set Architecture), as known and standardized in the IC design fields. Other languages or descriptions which will allow for extraction of control information may also be utilized equivalently, such as algorithms written in C or C++, DSP languages, whether floating point or integer, Matlab, Simulink, SPW, Ptolemy, standards specifications (often specified in languages such as C or C++), for example, and may include input of legacy code, such as code designed to implement an algorithm on a prior art processor. In addition, the system 10 may include other IC design tools and, in an exemplary embodiment, includes the LISATek system available through CoWare, Inc., which also provides other design tool features such as a compiler, a debugger, an assembler, a profiler, and a simulator. The algorithm or program is typically input electronically via I/O interface 60, either as directed by a user/designer or automatically.

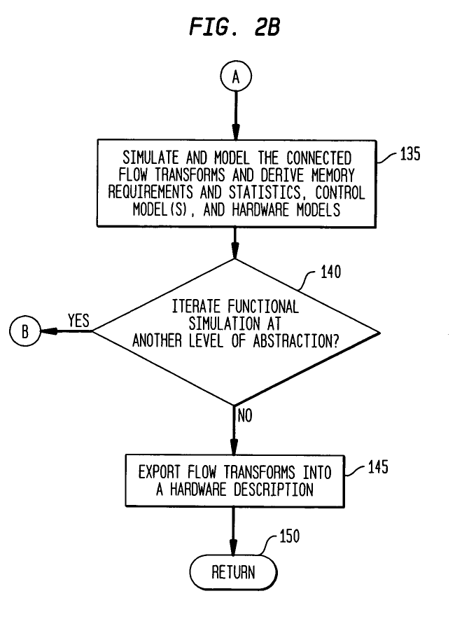

Next, in step 105, any parallel computation capability is extracted, such as through unrolling loops, duplication of processing elements in parallel, other parallel instantiations, and other methods known to those of skill in the field. In accordance with the present invention, the algorithm or other program is then hierarchically decomposed into a plurality of tasks and subtasks, which may be represented by processing or functional blocks, to a selected level of granularity, step 110. This parallel extraction and decomposition may be performed by a processor 55 or other component of system 10, typically by executing parsing and unroll programs, for example and without limitation. FIG. 3 is a diagram illustrating an exemplary hierarchical processing block decomposition in accordance with the teachings of the present invention. As illustrated, a processor 210 representing an entire algorithm or program is decomposed into a plurality of co-processors 215, each of which is further decomposed into a more detailed or fine-grained plurality of co-processors 220, as may be necessary or desirable, until the decomposition reaches a level of computational elements or blocks 225, with associated memory and control information.

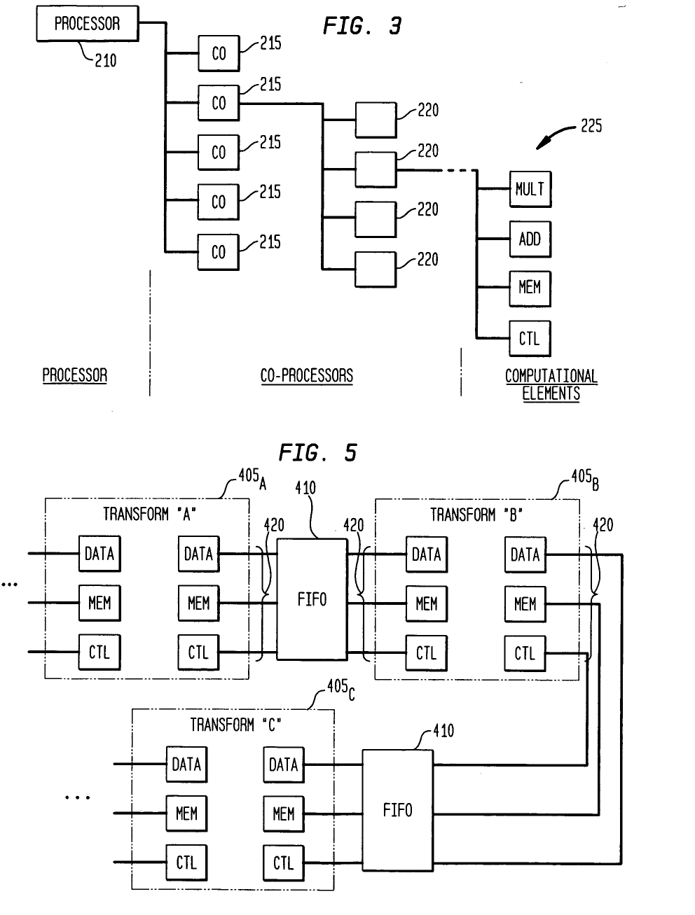

In exemplary embodiments, each level of decomposition may be displayed (via display 40) to the user/designer as a separate view, with clicking (via pointing device 25) on a processor 210 or co-processor (215, 220) resulting in opening a more detailed view (at the next, more detailed level of decomposition), until the level of the most highly detailed view being utilized. Conversely, as utilized in the various simulations and verifications discussed below, the more detailed views and more concrete decompositions may be rolled back up into the less detailed views and more abstract blocks (220, 215 and 210), with associated details automatically incorporated or subsumed within the more abstract level, such as simulated or modeled timing and delay statistics, discussed below. For example, the more detailed, concrete computational elements and functional blocks (e.g., co-processors 220) may be rigorously modeled and tested, with all associated timing, latency, power and other parameters determined. Such parameters will already be integrated for subsequent modeling (such as for implementation of other algorithms), so design and verification of subsequent designs do not need to repeat such detailed modeling, with all such parameters already embedded in the component models. An exemplary decomposition for a portion of a H.264 decoder is also discussed below with reference to FIG. 4.

The decomposition to the various co-processor (215, 220) and computational elements 225 may be accomplished by a processor 55, such as by mapping parsed functionality to a library of co-processors (215, 220) and computational elements 225 stored in a memory 65 (or database 70). Such libraries may be provided by a design tool vendor, may be input by the user/designer, or may be created by the methodology described herein.

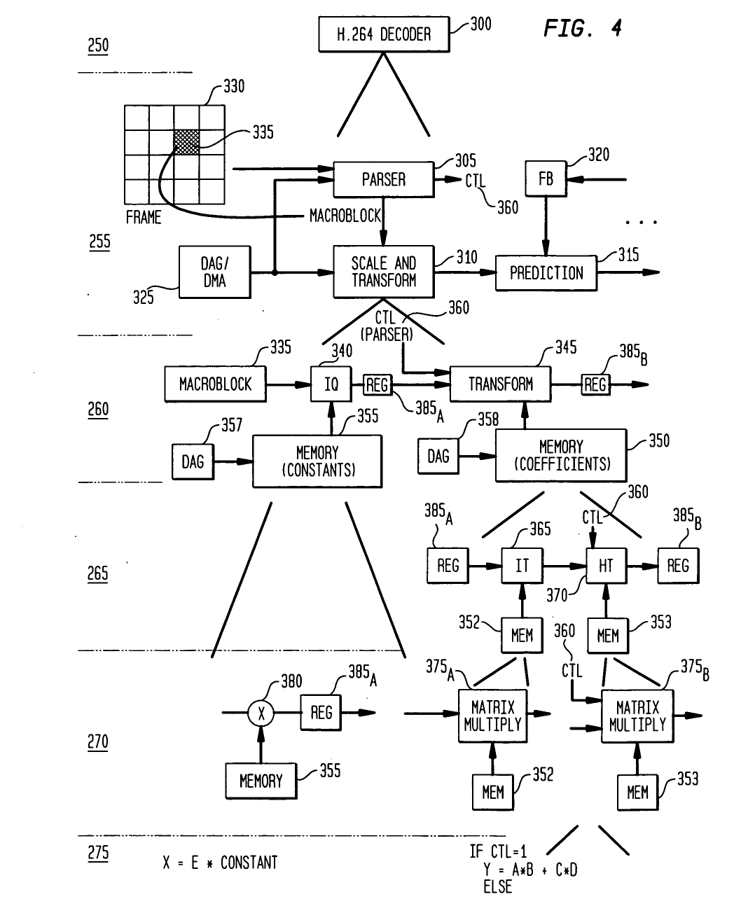

Referring again to FIG. 2, for each task or subtask (represented by a co-processor block 220 having a plurality of computational elements 225), in step 115, data flow, control flow, and memory flow information is extracted. Next, in step 120, the data flow, control flow and memory control is combined to form a self-contained task module referred to herein as a “flow transform”. As a consequence, a flow transform includes all data flow, control flow and memory flow for a selected task, such as a Fast Fourier Transform (FFT), Discrete Cosine Transformation (DCT), or if greater detail is required, the flow transform may be at a higher level of granularity, such as the “butterfly” operations utilized in DCT and FFT operations. Representative flow transforms are illustrated in FIG. 5. In addition, each flow transform (or task module) will have a well-defined, generic interface (e.g., using primitive scalars), which later may be combined to form complex, architecture-specific interface types.

This well-defined, generic interface facilitates coupling of such flow transforms in virtually any order by a designer or other user, without requiring specific knowledge of the inner workings or details of the flow transform itself. The well-defined data, control and memory interface (as input and output from any selected flow transform) allows a plurality of flow transforms to be connected together as building blocks to implement any selected algorithm, analogously to creating a chain by coupling one link after another. Such implementations may then be (iteratively) tested, as described below. In addition, the resulting architectural elements utilized to implement such flow transforms may also be manipulated as building blocks to instantiate any selected algorithm in an IC, such as an adaptive IC allowing such interconnection through a programmable or adaptive interconnect among computational elements.

FIG. 4 is a block diagram illustrating an exemplary hierarchical processor decomposition for a portion of a H.264 decoder in accordance with the teachings of the present invention. The H.264 decoder is a single block or algorithm 300 at the most abstract level 250, which is then decomposed (in part) into a parser 305, scale and transform block 310, prediction block 315, feedback block 320, with input data being a frame 330 (and subsequent selected macroblock 335), and with the input data accessed from a register or other memory using addressing and memory control provided by data address generator (DAG) or direct memory access (DMA) 325, illustrated as level 255. The scale and transform block 310 is then decomposed further (level 260) into a scalar multiply (IQ) 340 and a transform block 345, each having inputs from memories 355 and 350, respectively, and providing outputs to other memories, namely, registers 385_{A} and 385_{B}. In addition, data input of macroblock 335 is provided to the scalar multiply (IQ) 340, and control 360 information (from parser 305) is provided to the transform block 345. Transform block 345 is further decomposed into integer transform (IT) block 365 and Hadamard transform (HT) block 370, each having inputs from memories 352 and 353, respectively (level 265). In exemplary H.264 algorithms, the Hadamard transformation is only performed on a macroblocks 335 representing luminance “Y” (rather than chrominance CR or CB). Such a determination is performed by the parser 305, which provides a corresponding control bit (360), determining whether the Hadamard transformation is needed. The integer transform (IT) block 365 and Hadamard transform (HT) block 370, in turn, may be further decomposed (level 270) into matrix multiplications (375_{A} and 375_{B}), while the scalar multiply (IQ) 340 may be represented by a multiplication block 380. Finally, these operations may be represented by instructions or compute primitives (level 275), such as “x=E* CONSTANT” for the scalar multiply (IQ) 340 and the illustrated if-then-else statement, with “y=A*B +C*D” representing the Hadamard transformation when the control bit (CTL)=1 (indicating a luminance macroblock).

As illustrated in FIG. 4, exemplary memory flows are illustrated, for example, in memories 350 and 355 with corresponding DAGs 358 and 357, with their additional decompositions into registers 385_{A} and 385_{B}, and memories 352 and 353 (DAGs not illustrated separately). Similarly, data flow interconnections are illustrated via the input and output data lines of the various functional and compute blocks, and may also include the illustrated register usage. Similarly, the control flow (360) is illustrated as coming from the parser 305, and is illustrated for the matrix multiplication 375_{B} as a single control bit. 10601 As the components of each of the various views (represented by the various decomposition levels (255, 260, 265, 270, and 275) are modeled, tested and verified, as mentioned above, the associated parameters may be integrated as a model and subsumed within a higher-level model for each more abstract level. For example, the matrix multiply 375 components at level 270 may be modeled and verified to be cycle-accurate, transaction-accurate (or transactional-accurate), or functionally-accurate, with all such associated parameters then integrated into the models of the next higher level 265, such as the integer transform 365 and the Hadamard transform 370. This allows the user/designer to have much more rapid design and simulation at the higher levels of abstraction, yet still have cycle-accurate, transaction-accurate and/or functionally-accurate testing and verification.

For example, as used herein, functionally-accurate implies providing a correct result, without regard to order, e.g., a+b+c=result. Similarly, transactionally-accurate includes functionally accurate, with additional ordering, such as (a+b)+temp and temp+c=result, and cycle-accurate implies an accurate data ordering based on timing (clock cycles), such as time 0: a; time 3: b; time 7: temp=a+b; time 12: c; time 20: result+temp+c.

As a consequence, the hierarchical processing block decomposition of the present invention preserves data flow information, control flow information, and memory flow information, which is combined into a “flow transform” (step 120, FIG. 2). Each such flow transform is a self-contained module which may then be simulated and modeled, alone or in conjunction with other flow transforms representing other tasks. Importantly, flow transforms may be manipulated and combined to instantiate a plurality of algorithms. As a consequence, a flow transform is determined for every task, repeating steps 115 and 120 until there are no further flow transforms to be determined, step 125. When all flow transforms have been determined for the selected algorithm, the flow transforms are linked or connected to represent the algorithm, step 130, using an interconnect, such as a memory interconnect (such as FIFOs (first-in first-out memories)) to provide modeling interconnect, provide I/O and memory modeling, and to represent the actual interconnections which may be established in the actual IC. 3. Other types of interconnect may also be utilized in addition to a memory interconnect generally or a more specific memory types such as a first-in first-out (FIFO) memory, including interconnect such as a switch or a bus.

FIG. 5 is a block diagram illustrating an exemplary flow transform and FIFO connection for system modeling and simulation in accordance with the teachings of the present invention. As illustrated in FIG. 5, an algorithm (or portion thereof) utilizes three flow transforms 405 (illustrated as flow transforms 405_{A}, 405_{B}, and 405_{c}), representing data flow, control flow, and memory flow, which are connected to each other via memory interconnect (FIFOs) 410. Each of the flow transforms 405 has a well-defined (repeatable or standardized) interface, allowing connection to any other flow transform 405 (via memory interconnect 410). This data flow version of the algorithm, coupling flow transforms 405 via FIFOs 410, may then be simulated and modeled, step 135, as discussed in greater detail below, providing valuable information such as memory requirements and statistics, control information (such as control bits), cycle-accurate and transaction-accurate information, and may be utilized to generate control and hardware models. In addition, control flow may be modeled and compared in a plurality of ways, e.g., such as utilizing a state machine, a processor, or a program counter. Also for example, memory interconnect (FIFO) 410 dynamics provide a memory model for the algorithm, providing information such as, for example, concerning how and when they are filled, and when and how data computations are triggered, memory sizes, numbers of memories, data access patterns, bandwidth, latency, DAG/DMA requirements (e.g., 2D or 3D, speed of performance), etc. Such memory modeling is also useful in the architecture design, such as for providing distributed versus centralized memories. This is in sharp contrast with prior art data flow modeling, which has historically utilized infinite memory availability and infinite memory requirements and has not provided detailed memory views. The modeling and simulation may also compare and contrast different computational implementations, in addition to control and memory implementations.

Referring again to FIG. 2, this modeling process may then continue iteratively, step 140, returning to step 110, for functional simulation at different levels of abstraction (e.g., levels 250, 255, 260, 265, or 270). Using this modeling, the desired level of granularity of the computation elements may be determined and specified. Once a desired level of performance and refinement has been achieved, the flow transform models may be exported into a hardware description, such as RTL, SystemC, Verilog, VHDL, XML, SPW, or a software description (such as to run on an embedded processor), step 145, and the method may end, return step 150. In addition, based upon simulation and modeling of any resulting hardware elements defined in the flow transforms, additional iterations of the methodology of FIG. 2 may also be utilized.

Following the methodology of the present invention, an instruction-based programming language may be utilized to architect (and not just model) a non-instruction based system, such as a data flow system IC architecture. The simulation and modeling using the flow transforms can create a “netlist” of computational elements for design of the IC, and the designer can then determine if more elements or a different mix of elements should be utilized to improve performance, or decrease IC area or power dissipation, for example. The creation and preservation of memory flow information, such as register usage, provides memory and interconnect requirements. The present invention also preserves control instructions, which is generally unavailable in the prior art for data flow architecture environments. A combined flow transform is provided, integrating data flow, control flow, and memory flow. The various flow transforms which are generated and correspond to an algorithmic task or function, in turn, may be combined in any of a plurality of ways to express an algorithm as data flow, yet preserving any needed control and memory information as integral blocks. In addition, as discussed below, the creation and modeling of a flow transform in accordance with the present invention can be combined with a larger design tool flow for creation of adaptive computing IC architectures.

FIG. 6 is a block and flow diagram illustrating an exemplary Algorithmic ESL design, simulation and modeling automation platform system embodiment 500, referred to herein as an “Algorithmic ESL system” 500, in accordance with the teachings of the present invention. The Algorithmic ESL system 500 illustrated in FIG. 6 provides an infrastructure to (1) architect an IC, such as an adaptive computing IC or “system-on-a-chip” (“SoC”); (2) generate applications to run on the architecture; (3) functionally simulate algorithms and applications; (4) simulate and model the architecture with given applications; (5) simulate and model the applications as operating on the target architecture; and (6) compile the application to the target architecture (illustrated in FIG. 7). The Algorithmic ESL system 500 (and 600, below) is embodied as one or more systems 10 and/or apparatuses 50 illustrated and discussed with reference to FIG. 1.

The Algorithmic ESL system 500 may generally be divided into 2 portions, an architecture design platform (illustrated in FIG. 6 as the portion below the dashed line) and an application design platform (illustrated in FIG. 6 as the portion below the dashed line). As a significant feature of the Algorithmic ESL system 500, the application designer need not be aware of any of the architecture design requirements and parameters, and can simply capture software application or other algorithms at an abstract level, with the various models generated in the architecture design platform automatically integrated or rolled-up to the higher, more abstract level. For example, the application designer does not need to know about device parameters and parasitics, interconnect delays, binding of tasks to IC resources, etc., but is still provided at the abstract level with the means to specify requirements, and to provide parameterization, control and prioritization, among other features.

The architecture design platform, as discussed above with reference to FIGS. 1-5, utilizes an instruction (or control) and memory-based modeling platform (510), utilizing input of selected algorithms or programs (525 and FIG. 2, step 100), architecture specifications (530), and P3 or R3 requirements (535), creating the integrated flow transforms (545). For example, the architecture specifications may be initial designs of computational elements (225), which are then successively modified and refined through use of the architecture design platform of the Algorithmic ESL system 500. As discussed above, the various connected flow transforms are (iteratively) simulated and modeled (510 and FIG. 2, step 135 and 140), which may also include interactive use of the system modeling and simulation platform (540). For example, the instruction (or control) and memory-based modeling (510) may use the flow transforms (545) and architecture specifications 530 to generate hardware descriptions such as RTL computational elements (560 and FIG. 2, step 145), which are then modeled by system modeling and simulation platform (540) to generate cycle-accurate (“CA”) and transaction-accurate (“TA”) computational element models 555, CA and TA system models 505, P3 and/or R3 statistics (565) and other system performance statistics 515. The architecture designer then utilizes these CA and TA computational element models 555, CA and TA system models 505 and performance statistics 515, 565 to successively refine the various RTL computational elements (560) and CA and TA computational element models 555. As mentioned above, the instruction (or control) and memory-based modeling platform (510) may be implemented in a LISATek environment, for example, with the additional functionality and extensions discussed and illustrated herein. Also as mentioned above, other instruction or control-based platforms may also be utilized and are within the scope of the present invention.

The system modeling and simulation platform (540) may be implemented utilizing a wide variety of platforms available from various vendors. The system modeling and simulation platform (540) provides a common platform to link and integrate algorithmic (application) development with hardware development, and to provide corresponding simulation and verification, among other functionality. In an exemplary embodiment, SystemC has been selected to provide this common platform (as the system modeling and simulation platform (540)) to link, as a single framework, an application and system design platform 520 and the instruction (or control) and memory-based modeling platform (510). Platforms provided by other vendors, such as the SPW and LISATek platforms, have then been modified by providing SystemC conduits, for the corresponding information to be converted and/or exported into the common SystemC platform. In an exemplary embodiment, a ConvergenC platform from CoWare has been utilized, while an OSCI System C modeling platform could be utilized equivalently. Other platforms and non-SystemC platforms may be utilized equivalently. For such alternative embodiments, rather than providing SystemC-compatible descriptions and files, the application and system design platform 520 and the instruction (or control) and memory-based modeling platform (510) should be adapted to provide compatible descriptions and files suitable for the selected system modeling and simulation platform (540), such as a Cadence modeling platform. The Algorithmic ESL system 500 simply requires that the outputs of the application and system design platform 520 and instruction (or control) and memory-based modeling platform (510) be provided or capable of being converted into a format which is usable by the system modeling and simulation platform (540), such as to provide the sophisticated level of interactivity and abstraction available with the Algorithmic ESL system 500.

The application and system design platform 520 is utilized by a system or application designer to create and model applications for operation on a selected architecture, generally interactively with the system modeling and simulation platform 540 (which may be running in the background). As mentioned above, the system or application designer does not need to interact directly with or have knowledge of the system modeling and simulation platform 540. The application and system design platform 520 receives the “design intent” of the application as inputs, generally in the form of architectural definitions 570 (such as macrolibraries, IC libraries to implement specific functions (e.g., DCTs, FFTs, DAGs, DMAs), computational elements existing on the IC, contexts for implementations of configurable architectures, and other types of instructions (e.g., C or C++ code)), graphical data flow diagrams 575 representing a selected or given algorithm, and P3 and/or R3 specifications 580. Transparently to the user/designer, the application and system design platform 520 also receives input from the instruction (or control) and memory-based modeling platform (510), such as the CA and TA computational element models 555 and the P3 and/or R3 statistics 565.

The application and system design platform 520 then performs functional simulations of the application (or any portions thereof, such as for testing of application modules or components), providing functional models which can be evaluated by the system designer. On the basis of these results, the application or system designer may then modify the application, repeat the functional simulations, and continue with this iterative process until the functional model has been verified to the required level of performance and to meet other specified requirements. A satisfactory application functional model is then provided (typically as a database) to the system modeling and simulation platform 540, for simulation and modeling of the application (or algorithm) on the target IC architecture.

For example, the application and system design platform 520 then provides various selectable outputs, such as computational element compositions files 585 (the number and type of computational elements to implement the algorithm), any P3 and/or R3 constraints 590 for the given algorithm, and computational element code 595 (such as design XML which may be mapped to interconnect the various computational elements, or contexts utilized to configure adaptive or configurable computational elements). These outputs, in turn, are utilized by the system modeling and simulation platform (540) to provide functional and/or behavioral simulation and modeling of the application (or algorithm) on the target IC architecture, to provide an IC functional model, and-to provide corresponding feedback, generally iteratively, to the designer via the application and system design platform 520, allowing the designer to modify and refine the algorithm based on performance statistics (515) and other parameters. Typically, the system modeling and simulation platform 540 is adapted to compare the application functional model with the IC functional model, and to provide the corresponding results back to the application or system designer.

In addition, the functional and behavioral simulation and modeling of the application on the target IC provided by the system modeling and simulation platform 540 may be incremental or modular. For example, as one aspect of an application is prepared, such as a DCT or FFT module, that module may be ported into the system modeling and simulation platform 540, which will provide a corresponding portion (module) of the functional IC model. This process may occur in the background, while the system or application designer continues to work with the application and system design platform 520. This incremental and concurrent approach is one of the features of the Algorithmic ESL system 500 that helps to significantly decrease development time cycles and time to market.

Another important result of the integrated Algorithmic ESL system 500 is that the functional IC model generated for each such module or component provides both verification and performance results which may then be utilized by the other platforms (520, 510) and integrated directly, without repeating those modeling and computation steps. In addition, these results are then automatically embedded (rolled-up) in the overall models, allowing the designer to work at a more abstract level, yet simultaneously allowing the designer to drill-down as needed into these more concrete details.

As part of the application functional testing, the application and system design platform 520 can simulate and test various data traffic scenarios, test cases, verify computational element designs, test interconnect traffic patterns, control flow patterns, etc. The application and system design platform 520 may also do this at various levels of abstraction and views (as provided via the instruction (or control) and memory-based modeling platform (510) discussed above)), including the abstractions of the data flow, control flow, and memory flow, and any other abstractions of the memory hierarchy itself, such as the identifying multiple waypoints which exercise the memory subsystems. This ability to abstract and model a memory architecture as part of a data flow architecture and, indeed, as part of any embedded processing environment, is one of the many new and novel features of the present invention.

For example, instead of generating thousands of lines of C code, an algorithm may be captured in SPW (application and system design platform 520), followed by opening ports of the memory subsystems, and exporting the information into SystemC. The system modeling and simulation platform (540) may then connect to the memory subsystems and run the application, providing data traffic, memory flow information, and all other parameters and statistics utilized by those of skill in the field. Different versions of an algorithm may also be iteratively tested in this way, such as by simulating one solution with a first mix of computational elements, and comparing this to a simulation utilizing a second mix of computational elements performing the same algorithm. In addition, the use of the various levels of functional and architectural abstraction allow a designer to drill-down to increased detail as needed and to roll-up to a higher level of abstraction, allowing rapid design and development cycles.

Similarly, the SystemC framework implemented with the system modeling and simulation platform (540) can also model interconnect at different levels of abstraction and using different types and mixes of interconnect, such as switches, multiplexers, or routers. The interconnect can be modeled at these various levels, providing a simulation framework to form conclusions and make decisions based on objective, numeric evaluations.

The resulting simulation models, from both the application and system design platform 520 and the system modeling and simulation platform 540, are also scaleable, utilizing the various levels of abstraction. For example, initial functional simulations using the application and system design platform 520 may be run rapidly at a high level of abstraction, providing greater performance without requiring hardware emulation or hardware prototypes. In addition, higher accuracy and a more detailed analysis is provided utilizing the less abstract, more detailed and concrete levels illustrated, such as the block and elemental levels 265 and 270 illustrated in FIG. 4. As a consequence, very detailed implementations may be modeled utilizing very high levels of abstraction, enabling rapid simulation and significantly decreasing development time.

The application and system design platform 520 may be implemented utilizing an algorithmic programming language platform, such as platforms available from various vendors, with the inventive modifications and features of the Algorithmic ESL system 500, such as a Signal Processing Workstation (SPW) available from CoWare or Cadence, or other platforms such as those provided by MathWorks Simulink. A myriad of other equivalent platforms may be utilized, with the additional functionality described herein, and all such platforms are within the scope of the present invention.

Using the format-compatible database generated by the application and system design platform 520, the system modeling and simulation platform (540) generates a functional IC model of a version of the system or the final system (505), namely, a version based on the operation of the application on the target IC architecture, based on simulation and verification of computational elements, interconnect, memory subsystems, support models (such as clocking and I/O), with any hardware operating system (hardware OS) running on the model of the IC, and other IC parameters as used in the EDA and ESL fields, and utilizing the inputs provided from the instruction (or control) and memory-based modeling platform (510). As mentioned above, the system modeling and simulation platform (540) provides a unifying platform for both applications and architecture, such as linking SPW and SystemC, and linking LISATek and SystemC, for example.

This interaction between the application and system design platform 520 and the system modeling and simulation platform (540) allows rapid prototyping and comparisons by the designer of a plurality of versions, at different levels of simulation and verification, to allow rapid decisions for design trade-offs such as IC size and performance. In addition, the application and system design platform 520 can be utilized in conjunction with the instruction (or control) and memory-based modeling platform (510), such as to create an architecture with more or fewer computational elements or a different mix of computational elements. Also, the application and system design platform 520 is utilized to create the any code (contexts, control, assembly or other programs) to operate the resulting IC for implementation of the selected algorithm, not just for design and functional simulation.

For example, various applications may be created to run on different IC platforms, such as those with different mixes of computational elements, using application and system design platform 520. These functional simulations and models (e.g., in database 605 of FIG. 7) may then be provided to the system modeling and simulation platform 540, which can incorporate architecture specific models, such as interconnect effects, computational and other delay parameters, feedback and propagation delay parameters, allowing the developer to move from functional simulation to architectural-level simulation. In addition, these various simulations and modeling may also be performed at different levels of abstraction, all within the same simulation framework.

The Algorithmic ESL illustrated in FIG. 6 creates a novel convergence of different platforms to achieve novel results. An application and system design platform 520, such as a signal processing workstation, is utilized in a data flow environment to create data paths (interconnect) between and among computational elements, such as in an adaptive computing architecture. An instruction (or control) and memory-based modeling platform (510), such as those typically utilized for creating RISC processors, it utilized to generate control information for the full function, for controlling the interconnected computational elements having the selected data path, and to define any other control instructions (such as those to be executed via a hardware state machine or a program counter). In addition, the inventive Algorithmic ESL creates a common platform (and conduits) allowing data to move back and forth between the various tool sets, such as the application and system design platform 520, the system modeling and simulation platform 540, and the instruction (or control) and memory-based modeling platform 510.

The Algorithmic ESL also has particular application to the design and simulation of configurable and reconfigurable IC architectures. In such architectures, computational elements may be configured, through control bits (representing contexts or other types of control information), to perform multiple operations. In addition, the interconnect connecting a plurality of computational elements is also programmable or configurable, allowing a plurality of ways of connecting the computational elements for execution of a particular function or algorithm. The ability of the instruction (or control) and memory-based modeling platform (510) to create a flow transform, which includes not only data flow but also the memory flow and control information (for configuring the operations of the computational elements), is invaluable for implementing any selected algorithm. These architectures (with their corresponding configurations or contexts) may then be encapsulated as separate library elements in SystemC (or another RTL, VHDL or other compatible format utilized in the common platform), allowing rapid assembly into functional block for simulation and verification by system modeling and simulation platform 540. These architectures may also be provided as libraries (architecture definition files 570) and CA and TA computational element models 555 for use directly in application development (with application and system design platform 520) and system modeling (with system modeling and simulation platform 540).

FIG. 7 is a block and flow diagram providing another, more high-level illustration of an exemplary Algorithmic ESL design, simulation and modeling automation platform system embodiment 600 in accordance with the teachings of the present invention, and further illustrates the integration of the AESL platform with other significant components, such as compiler 650. In FIG. 7, the various outputs from the various platforms are illustrated as databases, namely, a functional models database 605 (provided by the application and system design platform 520 for use in interactive and iterative functional simulation and modeling), a computational element (or other device) models database 615 (provided by the instruction (or control) and memory-based modeling platform 510, in conjunction with the system modeling and simulation platform 540), and a cycle-accurate models database 610 (provided by the application and system design platform 520 in conjunction with the information from the computational element models database 615). The information stored in the cycle-accurate models database 610 and other databases (605, 615) may be in SystemC, XML, RTL, or another form of hardware description language, and includes a CA architecture model for the selected algorithm to be implemented on the target IC architecture (670). For example, in an exemplary embodiment, the application and system design platform 520 provides an XML netlist, defining all dataflow (computational elements and their interconnections), along with all corresponding control flow and memory flow, based upon the flow transforms. This information may then be compiled (IC compiler 650) to provide the IC binaries 660, which may be utilized to configure or program the IC 670, including providing defined data paths (via interconnect) and any configurations for computational elements.

As a consequence, the Algorithmic ESL system 500, 600 of the present invention provides an integrated application, IC design, and IC and application simulation and modeling solution, integrating algorithmic development with software and hardware design and implementation. In the illustrated embodiments, an application may be functionally modeled, further modeled using the target IC architecture, and compiled to that architecture, all using a single, integrated framework with full communication capability between and among the composite design and simulation platforms (510, 540, 520).

The Algorithmic ESL of the present invention also provides multiple levels and abstractions of simulation and modeling. At one level, represented by functional models database 605, functional simulation is provided, without regard to particular IC architectural effects. At other levels, simulation and modeling is provided for computational elements and different platforms, incorporating any selected IC parameters. At yet another level, complete device gate-level characteristics may be included, such as transistor-level parasitics, to provide functional and architectural simulation and modeling. In addition, each of these various levels may be back-annotated or fed back into other simulation and modeling levels, to provide further IC refinements and to roll-up more detailed simulations into the higher level, more abstract simulations and views. Of particular importance, an application designer does not need to perform verification at a detailed level, as that information is already embedded in the models utilized and generated via the instruction (or control) and memory-based modeling platform (510) and system modeling and simulation platform (540). The Algorithmic ESL system 500 allows applications and other software to be captured at a high level in application and system design platform 520, yet concurrently mapped to, modeled, and compiled on the target architecture. At the same time, parameterization and control (such as for P3 requirements) is available to the system designer, allowing high-level trade-offs for modeling and to guide the system compiler 650.

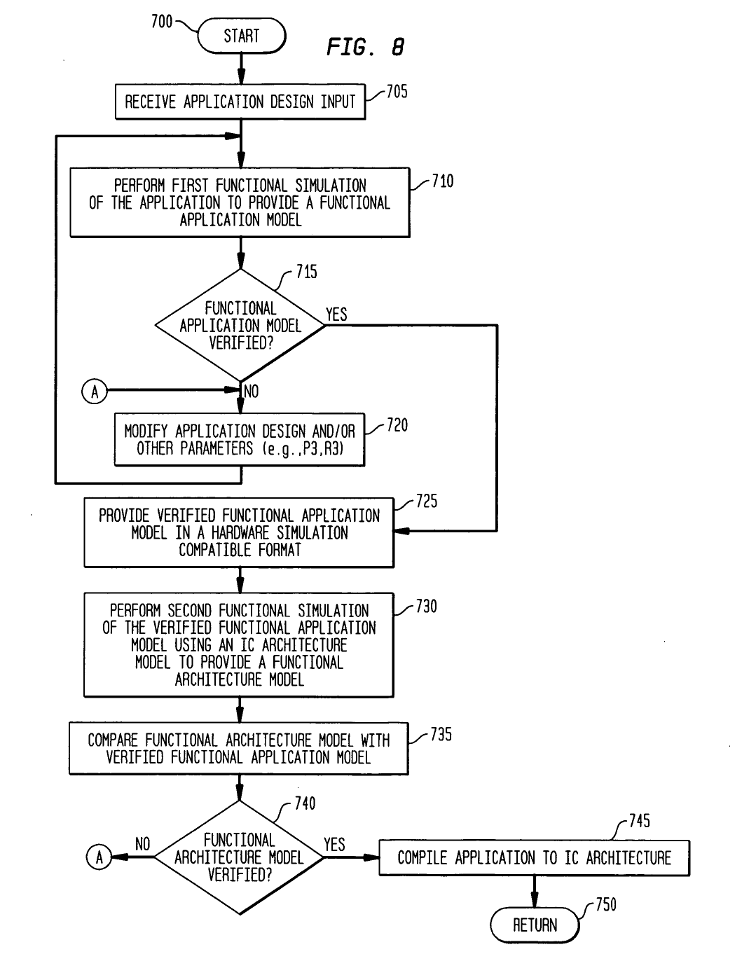

FIG. 8 is a flow diagram illustrating an exemplary method embodiment for design, simulation and modeling of integrated circuitry in accordance with the teachings of the present invention, and provides a useful summary. The method for electronic system level design and verification is typically computer-implemented, such as using the systems illustrated in FIG. 1. The method begins, start step 700, with receiving an application as design input, typically from the system or application designer, step 705. Other input may also be received as discussed above, such as a plurality of architecture definition files, with the plurality of architecture definition files determined from instruction/control and memory-based integrated circuit modeling platform 510. Next, in step 710, the method performs a first functional simulation of the application to provide a functional application model, typically by the application and system design platform 520. The functional application model may be verified in step 715; if the model is not verified, the method proceeds to step 720, with changing or modifying the application design and/or other parameters, such as P3 and/or R3 requirements, followed by repeating the first simulation. As indicated above, the simulation, verification and modification steps may continue iteratively, until the functional application model is verified to the designer's specifications or satisfaction.

When the functional application model has been verified in step 715, the method proceeds to step 725, and provides the verified functional application model in a hardware simulation compatible format, such as SystemC, RTL, Verilog, or VHDL, also typically by the application and system design platform 520. In an exemplary embodiment, the verified functional application model is provided as an application netlist of computational elements and interconnections. Next, in step 730, a second functional simulation is performed using the verified functional application model in the hardware simulation compatible format and using an integrated circuit architecture model to provide a functional architecture model, typically by the system modeling and simulation platform (540). The functional architecture model is compared with the verified functional application model, step 735. Through these comparisons and other evaluations, the functional architecture model may be verified, step 740, and using the verified functional architecture model, the application may be compiled to an integrated circuit architecture represented by the integrated circuit architecture model, step 745., and the method may end, return step 750. When the functional architecture model is not verified in step 740, the method returns to step 720 and iterates, typically interactively with the system or application designer, until a satisfactory functional architecture model is verified, as discussed above.

Also as discussed above, the methodology may include generating a plurality of cycle-accurate computational element models; and incorporating the plurality of cycle-accurate computational element models into the integrated circuit architecture model. The plurality of cycle-accurate computational element models are generated in the hardware simulation compatible format, to facilitate use in the common platform. In addition, receiving the application may further comprise: receiving a plurality of architecture definition files; receiving a plurality of dataflow diagrams; and receiving performance specifications.

In addition, the methodology illustrated in FIG. 8 may be performed on a component or module of a plurality of modules comprising the application. For example, one module of an algorithm may be functionally simulated, verified, modeled by the system modeling and simulation platform (540), as a background process, for example, while the other functional simulations are proceeding with other modules.

The inventive Algorithmic ESL also provides a fully integrated solution. It allows an application to be captured and developed at an abstract level. It further allows it to be modeled and verified at abstract levels, compared using different architectures and hardware versions, and finally compiled to a selected architecture, all within the same design and development tool suite.

While the invention is particularly illustrated and described with reference to exemplary embodiments, it will be understood by those skilled in the art that numerous variations and modifications in form, details, and applications may be made therein without departing from the spirit and scope of the novel concept of the invention. Some of these various alternative implementations are noted in the text. It is to be understood that no limitation with respect to the specific methods, systems, software and apparatus illustrated herein is intended or should be inferred. It is, of course, intended to cover by the appended claims all such modifications as fall within the scope of the claims.

1. A computer-implemented method for electronic system level design and verification, the method comprising:
(a) receiving an application as design input;
(b) performing a first functional simulation of the application to provide a functional application model;
(c) verifying the functional application model;
(d) providing the verified functional application model in a hardware simulation compatible format;
(e) performing a second functional simulation using the verified functional application model in the hardware simulation compatible format and using an integrated circuit architecture model to provide a functional architecture model; and
(f) comparing the functional architecture model with the verified functional application model.

2. The method of claim 1, wherein step (a) of receiving the application further comprises:
receiving a plurality of architecture definition files, the plurality of architecture definition files determined from control and memory-based integrated circuit modeling.

3. The method of claim 1, further comprising:
generating a plurality of cycle-accurate, transactional-accurate, or functionally-accurate computational element models; and
incorporating the plurality of cycle-accurate, transactional-accurate, or functionally-accurate computational element models into the integrated circuit architecture model.

4. The method of claim 3, wherein the plurality of cycle-accurate, transactional-accurate, or functionally-accurate computational element models are generated in the hardware simulation compatible format.

5. The method of claim 4, wherein the hardware simulation compatible format is SystemC, RTL, Verilog, or VHDL.

6. The method of claim 1, wherein step (a) of receiving the application further comprises:
receiving a plurality of architecture definition files;
receiving a plurality of dataflow diagrams; and
receiving performance specifications.

7. The method of claim 1, wherein step (d) of providing the verified functional model further comprises:
providing the verified functional application model as an application netlist of computational elements and interconnections.

8. The method of claim 1, wherein step (e) of performing the second functional simulation further comprises:
generating a cycle-accurate functional architecture model of at least one component of the application.

9. The method of claim 1, wherein steps (b), (c), (d) and (e), inclusive, further comprise:
(b1) performing the first functional simulation of a first module of a plurality of modules comprising the application to provide the functional application model of the first module; and
(c1) verifying the functional application model of the first module;
(d1) providing the verified functional application model of the first module in the hardware simulation compatible format;
(e1) performing a second functional simulation of the first module using a model of an integrated circuit architecture and using the verified functional application model of the first module in the hardware simulation compatible format to provide a functional architecture model of the first module, and concurrently performing the first functional simulation of a second module of a plurality of modules comprising the application to provide a functional application model of the second module.

10. The method of claim 1, further comprising:
using the comparison of the functional architecture model with the verified functional application model, modifying at least one parameter and repeating steps (b) through (f), inclusive.

11. The method of claim 1, further comprising:
verifying the functional architecture model; and
using the verified functional architecture model, compiling the application to an integrated circuit architecture represented by the integrated circuit architecture model.

12. A computing system for algorithmic electronic system level design, the computing system comprising:
a plurality of databases, a first database of the plurality of databases adapted to store a plurality of functional models, a second database of the plurality of databases adapted to store a plurality of computational element models, and a third database of the plurality of databases adapted to store a plurality of hardware definition representations;
an application design processor coupled to the first database, the application design processor adapted to perform a first functional simulation of an algorithm using a plurality of computational element architecture definitions to generate a first selection of a plurality of computational elements and corresponding control code for an implementation of the algorithm;
a control and memory modeling processor coupled to the second database, the control and memory modeling processor adapted to generate a plurality of flow transforms from the algorithm and to convert the plurality of flow transforms into the plurality of plurality of computational element models; and
a system simulation processor coupled to the second databases and the third database, the system simulation processor adapted to convert the plurality of computational element models into the plurality of hardware definition representations and to perform a second functional simulation of the algorithm using the plurality of computational element models corresponding to the first selection and the corresponding control code.

13. The system of claim 12, wherein the control and memory modeling processor is further adapted to generate the plurality of flow transforms from the algorithm coded in an instruction-based language.

14. The system of claim 12, wherein the control and memory modeling processor is further adapted to combine data flow, control flow, and memory flow information to generate a flow transform of the plurality of flow transforms.

15. The system of claim 12, wherein the system simulation processor is further adapted to generate a cycle-accurate computational element model of the plurality of computational element models which further comprises control information for configuration of a configurable computational element.

16. A system for electronic system level design and verification, the system comprising:
a first processor adapted to receive an application as design input, perform a first functional simulation of the application to provide a functional application model, verifying the functional application model, and provide the verified functional application model in a hardware simulation compatible format; and
a second processor coupled to the first processor, the second processor adapted to perform a second functional simulation using the verified functional application model in the hardware simulation compatible format and using an integrated circuit architecture model to provide a functional architecture model.

17. The system of claim 16, further comprising:
a third processor coupled to the first processor and to the second processor, the third processor adapted to determine a plurality of architecture definition files and to provide the plurality of architecture definition files as input to the first processor.

18. The system of claim 16, wherein the second processor is further adapted to generate a plurality of cycle-accurate computational element models in the hardware simulation compatible format and to incorporate the plurality of cycle-accurate computational element models into the integrated circuit architecture model.

19. The system of claim 16, wherein the first processor is further adapted to provide the verified functional application model as an application netlist of computational elements and interconnections.

20. The system of claim 16, wherein the second processor is further adapted to verify the functional architecture model; and wherein the system further comprises:
a fourth processor coupled to the second processor, the fourth processor adapted to use the verified functional architecture model to compile the application to an integrated circuit architecture represented by the integrated circuit architecture model.

21. A system for algorithmic electronic system level design, the system comprising:
an interface for receiving an algorithmic description;
a memory adapted to store a plurality of computational element architecture definitions and a plurality of cycle-accurate computational element models; and
a processor coupled to the memory and to the interface, the processor adapted to perform a first functional simulation of the algorithm using the plurality of computational element architecture definitions to generate a first selection of a plurality of computational elements and corresponding control code for an implementation of the algorithm; and to perform a second functional simulation of the algorithm using a plurality of cycle-accurate computational element models corresponding to the first selection and the corresponding control code.

22. The system of claim 21, wherein the algorithm is defined by a plurality of interconnected dataflow diagrams.

23. The system of claim 22, wherein the processor is further adapted to map the plurality of interconnected dataflow diagrams to a corresponding plurality of computational elements; and generate an interconnection among the corresponding plurality of computational elements as defined by the plurality of interconnected dataflow diagrams.

24. The system of claim 21, wherein the processor is further adapted to convert the algorithm into a plurality of flow transforms.

25. The system of claim 21, wherein the processor is further adapted to combine data flow, control flow, and memory flow information to generate a flow transform of the plurality of flow transforms.

26. The system of claim 21, wherein the processor is further adapted to generate a cycle-accurate computational element model of the plurality of cycle-accurate computational element models which further comprises control information for configuration of a configurable computational element.

27. The system of claim 21, wherein the processor is further adapted to perform the second functional simulation utilizing a plurality of integrated circuit architecture models, the plurality of models comprising at least two of the following models: an interconnect model, a memory model, an input and output model, a clocking model, and an integrated circuit operating system model.

28. The system of claim 21, wherein the processor is further adapted to perform a third functional simulation using the plurality of computational element architecture definitions to generate a second selection of a plurality of computational elements and corresponding control code for an implementation of the algorithm; to perform a fourth functional simulation of the algorithm using a plurality of cycle-accurate computational element models corresponding to the second selection and the corresponding control code; and to compare the second functional simulation and fourth functional simulation.

29. The system of claim 21, wherein the processor is further adapted to perform the first and second functional simulations at a plurality of levels of abstraction.

30. The system of claim 21, wherein the processor is further adapted to roll-up a plurality of parameters from a each level of abstraction to the next higher level of abstraction.

31. A system for algorithmic electronic system level design, the system comprising:
a plurality of databases, a first database of the plurality of databases adapted to store a plurality of computational element architecture definitions, a second database of the plurality of databases adapted to store a plurality of cycle-accurate computational element models, and a third database of the plurality of databases adapted to store a hardware definition representation of the plurality of cycle-accurate computational element models; and
a processor coupled to the plurality of databases, the processor adapted to perform a first functional simulation of an algorithm using the plurality of computational element architecture definitions to generate a first selection of a plurality of computational elements and corresponding control code for an implementation of the algorithm; and to perform a second functional simulation of the algorithm using a plurality of cycle-accurate computational element models corresponding to the first selection and the corresponding control code.

32. The system of claim 31, wherein the processor is further adapted to generate a plurality of flow transforms from the algorithm coded in an instruction-based language.

33. The system of claim 32, wherein the processor is further adapted to combine data flow, control flow, and memory flow information to generate a flow transform of the plurality of flow transforms.

34. The system of claim 31, wherein the processor is further adapted to generate a cycle-accurate computational element model of the plurality of cycle-accurate computational element models which further comprises control information for configuration of a configurable computational element.

35. A computer-implemented method for algorithmic electronic system level design and simulation, the method comprising:
(a) inputting an algorithm;
(b) providing a plurality of computational element architecture definitions;
(c) functionally simulating the algorithm using the plurality of computational element architecture definitions;
(d) generating from the functional simulation a first selection of a plurality of computational elements and corresponding control code for an implementation of the algorithm; and
(e) functionally simulating the algorithm using a plurality of cycle-accurate computational element models corresponding to the first selection and the corresponding control code.

36. The method of claim 35 wherein the algorithm is defined by a plurality of interconnected dataflow diagrams.

37. The method of claim 36, wherein functional simulation step (b) further comprises:
mapping the plurality of interconnected dataflow diagrams to a corresponding plurality of computational elements; and
generating an interconnection among the corresponding plurality of computational elements as defined by the plurality of interconnected dataflow diagrams.

38. The method of claim 35 wherein the algorithm is defined by a plurality of flow transforms, and wherein each flow transform comprises data flow, control flow, and memory flow.

39. The method of claim 35 wherein a cycle-accurate computational element model of the plurality of cycle-accurate computational element models further comprises control information for configuration of a configurable computational element.

40. The method of claim 35, wherein functional simulation step (e) further comprises:
functional simulation utilizing a plurality of models, the plurality of models comprising at least two of the following models: an interconnect model, a memory model, an input and output model, a clocking model, and an integrated circuit operating system model.

41. The method of claim 35, further comprising:
repeating steps (a) to (c);
(d1) generating from the functional simulation a second selection of a plurality of computational elements and corresponding control code for an implementation of the algorithm;
(e1) functionally simulating the algorithm using a plurality of cycle-accurate computational element models corresponding to the second selection and the corresponding control code; and
(f1) comparing the functional simulations using the first selection and the second selection.

42. A machine-readable medium storing instructions for electronic system level design and verification, the machine-readable medium comprising:
a first program construct for receiving an application as design input and receiving a plurality of architecture definition files, the plurality of architecture definition files having been determined from control and memory-based integrated circuit modeling;
a second program construct for performing a first functional simulation of the application to provide a functional application model;
a third program construct for verifying the functional application model;
a fourth program construct for providing the verified functional application model in a hardware simulation compatible format;
a fifth program construct for performing a second functional simulation using the verified functional application model in the hardware simulation compatible format and using an integrated circuit architecture model to provide a functional architecture model; and
a sixth program construct for comparing the functional architecture model with the verified functional application model.

43. The machine-readable medium of claim 42, further comprising:
a seventh program construct for generating a plurality of cycle-accurate, transactional-accurate, or functionally-accurate computational element models; and
an eighth program construct for incorporating the plurality of cycle-accurate, transactional-accurate, or functionally-accurate computational element models into the integrated circuit architecture model.

44. The machine-readable medium of claim 42, further comprising:
a ninth program construct for providing the verified functional application model as an application netlist of computational elements and interconnections.

45. The machine-readable medium of claim 42, further comprising:
a tenth program construct for verifying the functional architecture model; and
an eleventh program construct for compiling the application, using the verified functional architecture model, to an integrated circuit architecture represented by the integrated circuit architecture model.
